(19) United States
(12) Patent Application Publication
(10) Pub. No.: US 2021/0347998 A1
(43) Pub. Date: Nov. 11, 2021

(54) SEALANT COMPOSITION

(71) Applicants: Dow Global Technologies LLC, Midland, MI (US); Rohm and Haas Company, Collegeville, PA (US)

(72) Inventors: Parvinder S. Walia, Midland, MI (US); Edwin Aloysius Nungesser, JR., Horsham, PA (US); Jack E. Hetzner, Reese, MI (US)

(21) Appl. No.: 17/282,900

(22) PCT Filed: Oct. 15, 2019
(86) PCT No.: PCT/US2019/056259

§ 371 Date: Apr. 5, 2021

Related U.S. Application Data
(60) Provisional application No. 62/752,744, filed on Oct. 30, 2018.

(51) Int. Cl. C09D 5/02; C09D 5/00; C09D 133/06; C09D 175/04; B29C 44/12

(52) U.S. Cl. CPC C09D 5/022; C09D 5/021; C09D 5/002; B29K 2075/00; C09D 175/04; B29C 44/12; C09D 133/062

(57) ABSTRACT

An aqueous acrylic emulsion sealant coating composition used for sealing stitched skins against leakage from polyurethane foam which has been applied to stitched skins, the composition including: (a) a first soft acrylic polymer phase component; and (b) a second aqueous phase component; a process for producing the sealant coating composition; a sealed stitched skin structure; a process for producing the sealed stitched skin structure; a polyurethane foamed article; and a process for producing the polyurethane foamed article.

### FIELD

The present invention relates to a sealant composition; and more specifically, the present invention relates to a sealant composition which is derived from an aqueous emulsion.

### BACKGROUND

Stitched skins for automotive interior applications like instrument panels (IPs), door panels (DP), trim and seating is a growing trend for craftsmanship. Visible stitching, sewn or simulated is perceived as luxurious. Stitching features are reminiscent of hand-crafted materials such as leather upholstery. These skins are typically back-foamed for soft touch with polyurethane (PU) foam. The presence of the needle holes from the stitching provides a pathway for the PU foam to leak out (or “bleed out”) through the needle holes during molding as shown in the photographs of FIGS. 1 and 2 (prior art). There is a growing trend of using stitched skins in automotive interiors; and a solution to the problem of PU foam leakage would be advantageous in the current automotive industry.

One typical way to solve the PU foam leakage problem is to apply seam tape to seal the seam stitch holes to prevent PU foam from leaking through the needle holes. In the textile industry, seam tape with an adhesive backing is well known; and various seam tape compositions are also known. However, applying a seam tape to a skin surface is a labor-intensive method (e.g., anywhere from 6-8 people per shift are needed for applying seam tape to a skin member) for sealing needle holes; and this labor-intensive seam tape application method can be a costly method to use. In addition, the seam tape application process of the prior art is disadvantaged because:
(1) The seam tape is applied manually on a stitching machine along with hot melt adhesive at ˜150 degrees Celsius (° C.).
(2) The seam tape is difficult to apply in complex geometries, especially corners, leading to a high degree of failure. For instance, seam tape tends to wrinkle and/or crease, and the seam tape is difficult to apply in corners and sharp radii areas. Even in flat areas, a slight turn in a stitch may require the use of multiple pieces of tape to follow the turn.
(3) The application of the seam tape requires an operator to turn the skin inside out to apply the seam tape adding time and cost to the method; and creating a high potential of damaging the skin materials being stitched.
(4) When using sealing tape, there is a high risk that the edges of the tape may become visible after PU foaming.
(5) A high scrap rate in IPs is being reported by molders that make automotive interior parts like instrument and door panels due to the inefficient sealing of the tape or the visual defects of the seal.

If an adhesive material, such as radically curing acrylates, cationic epoxy adhesives, ultraviolet light (UV) acrylates, and PU adhesives are used with the above seam tape application, such prior art processes require a curing step in the process which adds to the complexity of the seam sealing process.

Heretofore, a wide variety of materials and methods have been used to provide a seal to a stitched seam including, for example, the sealants and processes described in WO2002006578A1; U.S. Patent Application Publication No. US20160318461A1; U.S. Pat. No. 9,278,500B2; U.S. Pat. No. 5,723,182; EP1944342B1; U.S. Pat. No. 6,789,592B2; U.S. Pat. No. 6,401,643; and GB2346624A. However, in spite of the recent developments in seam sealing, there is still a desire in the industry for an automated process with improved sealing of seam stitch holes to prevent PU foam from leaking through the needle holes.

### SUMMARY

The present invention relates to a sealant coating composition which is derived from an aqueous emulsion, and more specifically, an acrylic aqueous emulsion. The acrylic aqueous emulsion sealant coating composition is useful for sealing stitched holes present in the stitched seam of soft skins having a polyurethane foam adhered to at least one side (e.g., the back side) of the soft skins. The acrylic aqueous emulsion sealant coating composition, when applied to the soft skin forms a film or coating that seals the stitched holes in the stitched skins against polyurethane leakage from the polyurethane foam attached to the stitched skins. Advantageously, the problems and difficulties of the prior art related to “bleeding out” or “leakage” of polyurethane from the polyurethane foam attached to the stitched skins can be solved by using the acrylic aqueous emulsion sealant coating composition of the present invention.

In accordance with the present invention, one embodiment is directed to an acrylic aqueous emulsion sealant coating composition including an admixture of: (a) a first polymeric phase component comprising a soft acrylic polymer resin; and (b) a second aqueous phase component comprising water as the medium. In the above two-phase emulsion system, the water is the continuous phase and the polymer is the dispersed phase.

Another embodiment of the present invention includes a process for producing the above sealant coating composition.

In another embodiment, the present invention includes a film or coating made from the above sealant coating composition.

Still another embodiment of the present invention is directed to a sealed stitched skin structure including a film or coating of the above sealant coating composition on at least one side of a stitched skin material.

Yet another embodiment of the present invention includes a process for producing the above sealed stitched skin structure.

Even still another embodiment of the present invention is directed to a polyurethane foamed article including a combination of the above sealed stitched skin structure and a polyurethane foam attached to at least one side of the above sealed stitched skin structure.

Even yet another embodiment of the present invention includes a process for producing the above polyurethane foamed article.

The above embodiments of the present invention including the acrylic aqueous emulsion sealant coating composition can be particularly useful in automotive applications.

### BRIEF DESCRIPTION OF THE DRAWINGS

FIG. 1 is a photograph showing a foamed stitched skin of the prior art.

FIG. 1A is an enlarged photograph showing the seam stitching of the foamed stitched skin of FIG. 1 with of a good seal.

FIG. 2 is a photograph showing a seam stitching of a foamed stitched skin of the prior art with seal leakage.

FIG. 3 is a photograph showing the good adhesion of the adhesive of Example 2 to PU foam, wherein the adhesive has been coated on a TPU skin.

FIG. 4 is a photograph showing the good adhesion of the adhesive of Example 2 to PU foam, wherein the adhesive has been coated on a TPU skin.

FIG. 5 is a photograph showing the good adhesion of the adhesive of Example 2 to PU foam, wherein the adhesive has been coated on a PVC skin.

FIG. 6 is a photograph showing a coating of the emulsion of Example 2 on a stitched skin of TPE.

FIG. 7 is a photograph showing PU foaming of a coated stitched skin of (A) TPU, (B) TPE, and (C) PVC.

FIG. 8 is a photograph showing PU foamed coated stitched skin from FIG. 7 after heat aging (A) TPU, (B) TPE, and (C) PVC.

FIG. 9 is a photograph showing PU foam leakage through stitch holes of a blank (no coating) stitched skin of TPE.

FIG. 10 is another photograph showing no PU foam leakage through stitch holes of a stitched skin of TPE, wherein the skin is painted with a coating applied at room temperature.

FIG. 11 is still another photograph showing no PU foam leakage through stitch holes of a stitched skin of TPE, wherein the skin is painted with a coating applied to the skin after the skin is heated.

FIG. 12 is a photograph showing PU foam leakage through stitch holes of a stitched skin of TPU, wherein the skin has no coating.

FIG. 13 is another photograph showing no PU foam leakage through stitch holes of a stitched skin of TPU, wherein the skin has a painted coating.

FIG. 14 is yet another photograph showing occasional leakage of PU through stitch holes of a stitched skin of TPU, wherein the skin has a sprayed coating.

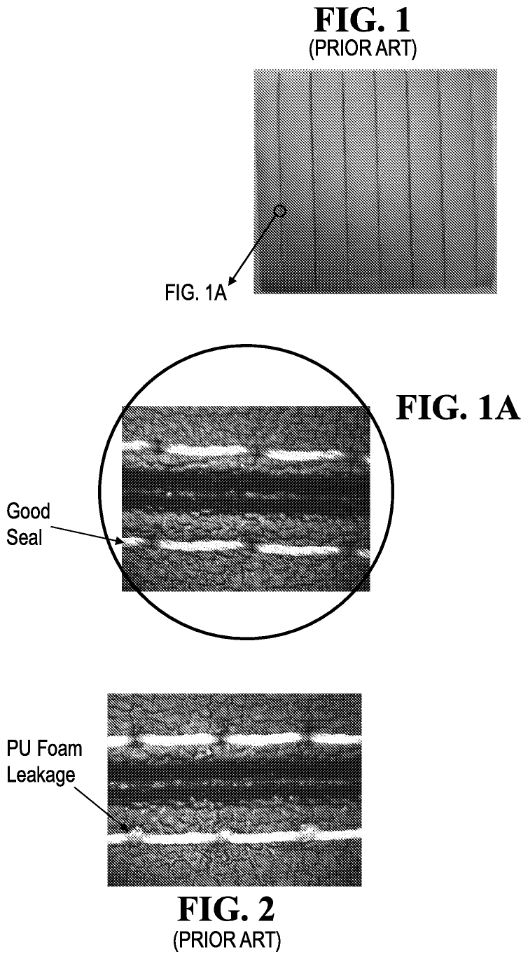

### DETAILED DESCRIPTION

In one broad embodiment, the acrylic aqueous emulsion sealant coating composition includes an admixture of: (a) a first polymeric phase component comprising a soft acrylic polymer resin; and (b) a second aqueous phase component comprising water as the medium. “Soft”, with reference to a polymer such as an acrylic polymer, herein means a polymer having a Shore A hardness of 40 to 90.

In one embodiment, the acrylic polymer useful in the emulsion composition of the present invention, as component (a), may be selected from one or more of the acrylic polymers described in U.S. Pat. No. 5,723,182. For example, the acrylic polymer used in the present invention may include esters, amides, and the like of (meth)acrylic acid, (meth)acrylonitrile, and the like. The acrylic polymer contains at least one copolymerized ethylenically unsaturated monomer such as, for example, a (meth)acrylic ester monomer including methyl acrylate, ethyl acrylate, butyl acrylate, 2-ethylhexyl acrylate, decyl acrylate, methyl methacrylate, butyl methacrylate, hydroxy ethyl methacrylate, hydroxypropyl methacrylate, aminoalkyl (meth)acrylates; styrene or substituted styrenes; butadiene; vinyl acetate or other vinyl esters; vinyl monomers such as vinyl chloride, vinylidene chloride, N-vinyl pyrollidone; and acrylonitrile or methacrylonitrile. In one preferred embodiment, the acrylic polymer component (a) of the acrylic emulsion includes for example a soft acrylic polymer.

In another embodiment, the present invention relates to a method for coating a skin member, such as leather; and to an aqueous composition useful for coating the skin member, such as leather, wherein the aqueous composition can be related to a multi-stage polymer prepared by emulsion polymerization. The aqueous coating composition is useful for sealing stitched holes present in the stitched seam of soft skin members having a polyurethane foam adhered to at least one side (e.g., the back side) of the soft skin members. A “seam”, with reference to a skin member, herein means the line formed by sewing and/or the stitches used to make such a line.

For example, in this embodiment of the present invention, the aqueous composition can comprise a multi-stage aqueous emulsion-polymer, i.e., at least a two-stage aqueous emulsion-polymer where each of the two polymers differ in composition; and the two stages can be formed in the following sequential fashion: (i) a predominantly acrylic first stage polymer comprising at least one copolymerized ethylenically unsaturated monomer and from 0.5 weight percent (wt %) to 10 wt % of a copolymerized monoethylenically-unsaturated carboxylic acid monomer, based on the weight of the first stage polymer, and (ii) a second stage polymer comprising at least one copolymerized ethylenically unsaturated monomer and from 0 wt % to 10 wt % of a copolymerized monoethylenically-unsaturated carboxylic acid monomer, based on the weight of the second stage polymer.

The multi-stage emulsion polymer contains a predominantly acrylic first stage polymer comprising at least one copolymerized ethylenically unsaturated monomer and from 0.5 wt % to 10 wt % of a copolymerized monoethylenically-unsaturated carboxylic acid monomer, based on the weight of the first stage polymer. The first stage polymer can also be substantially free from copolymerized multi-ethylenically unsaturated monomer. By “predominantly acrylic first stage polymer” used herein, it is meant that greater than 50 wt % of the copolymerized monomers forming the first stage polymer are acrylic, i.e., the monomers can be selected from esters, amides, and the like of (meth)acrylic acid, (meth)acrylonitrile, and the like; and mixtures thereof. For example, the first stage polymer can contain at least one copolymerized ethylenically unsaturated monomer such as, for example, a (meth)acrylic ester monomer including methyl acrylate, ethyl acrylate, butyl acrylate, 2-ethylhexyl acrylate, decyl acrylate, methyl methacrylate, butyl methacrylate, hydroxyethyl methacrylate, hydroxypropyl methacrylate, aminoalkyl (meth)acrylates; styrene or substituted styrene; butadiene; vinyl acetate or other vinyl esters; vinyl monomers such as vinyl chloride, vinylidene chloride, and N-vinyl pyrollidone; nitriles such as acrylonitrile or methacrylonitrile; and mixtures thereof. The use of the term “(meth)” followed by another term such as acrylate or acrylamide, as used herein, refers to both acrylates or acrylamides and methacrylates and methacrylamides, respectively.

As aforementioned, in one preferred embodiment, the first stage polymer contains a copolymerized monoethylenically-unsaturated carboxylic acid monomer, in an amount of, for example, from 0.5 wt % to 10 wt %; and in another embodiment, the acid monomer can be from 1 wt % to 5 wt %, based on the weight of the first stage polymer. The monoethylenically-unsaturated carboxylic acid monomer can be, for example, acrylic acid, methacrylic acid, crotonic acid, itaconic acid, fumaric acid, maleic acid, monomethyl itaconate, monomethyl fumarate, monobutyl fumarate, maleic anhydride, and mixtures thereof.

The first stage polymer used in the present invention can also be substantially free from copolymerized multi-ethylenically unsaturated monomers such as, for example, allyl methacrylate, diallyl phthalate, 1,4-butylene glycol dimethacrylate, 1,2-ethylene glycol dimethacrylate, 1,6-hexanediol diacrylate, divinyl benzene, and mixtures thereof. By “substantially free from copolymerized multi-ethylenically unsaturated monomers”, as used herein, it is meant that low levels (e.g., less than 0.1 wt % based on the weight of the first stage polymer) of the copolymerized multi-ethylenically unsaturated monomers present in the first stage polymer that might be inadvertently or adventitiously introduced as impurities in monoethylenically-unsaturated monomers are not excluded.

The first stage polymer that can be substantially free from containing a copolymerized multi-ethylenically unsaturated monomer, can also have a glass transition temperature (“Tg”) of generally less than 20° C. in one embodiment, from 20° C. to <−50° C. in another embodiment, from 0° C. to −40° C. in still another embodiment, and from −10° C. to −40° C. in yet another embodiment. The Tg of the first stage polymer can be measured by differential scanning calorimetry (DSC) using the mid-point in the heat flow versus temperature transition as the Tg value.

The first stage polymer can be contacted with a transition metal oxide, hydroxide, or carbonate at a pH of less than 9 in one embodiment, and at a pH of from 3 to 6 in another embodiment. The transition metal can be added to the first stage polymer in an amount greater than 0.1 equivalent of transition divalent metal per equivalent of copolymerized carboxylic acid monomer in the first stage polymer according to the process disclosed in U.S. Pat. No. 5,221,284.

The oxides, hydroxides, and carbonates of metals such as zinc, aluminum, tin, tungsten, zirconium, and mixtures thereof, are useful in some preferred embodiments because of the low cost, low toxicity, and low color of the metal in a dried coating. Zinc oxide can be used in one preferred embodiment. The transition metal oxide, hydroxide, or carbonate may be added slurried in water, optionally with an added dispersant such as, for example a low molecular weight polymer or copolymer of (meth)acrylic acid. The transition metal oxide, hydroxide, or carbonate may be added during the polymerization process or after the polymerization of one or more stages has been completed.

In another embodiment, the first stage polymer used in the present invention can also include chain transfer agents such as, for example, mercaptans; and chain transfer agents may be used in an amount effective to provide polymers having low molecular weights (e.g., molecular weights in the range of from 1,000 to 100,000 in one embodiment and from 1,000 to 50,000 in another embodiment).

The multi-stage emulsion polymer also contains a second stage polymer comprising at least one copolymerized ethylenically unsaturated monomer and from 0 wt % to 10 wt % of a copolymerized monoethylenically-unsaturated carboxylic acid monomer, based on the weight of the second stage polymer. The second stage copolymerized carboxylic acid monomer in the multi-stage copolymer can be substantially free from copolymerized multi-ethylenically unsaturated monomer. And the second stage polymer has a Tg of greater than 20° C. In addition, the Tg of the second stage polymer can be at least 10° C. higher than the Tg of the first stage polymer. Generally, the second stage polymer can be from 1 wt % to 50 wt % of the weight of the first stage polymer, based on dry polymer weights. The copolymerized ethylenically unsaturated monomer, copolymerized monoethylenically-unsaturated carboxylic acid monomer, and copolymerized multi-ethylenically unsaturated monomer of the second stage polymer can be defined and exemplified the same as for the first stage polymer described above.

The polymerization techniques which can be used to prepare the aqueous multi-stage emulsion-polymers are known in the art such as the techniques described in U.S. Pat. Nos. 4,325,856; 4,654,397; and 4,814,373. In the multi-stage polymerization process of the present invention, at least two stages differing in composition can be formed in sequential fashion.

Conventional surfactants may be used such as, for example, anionic and/or nonionic emulsifiers such as, for example, alkali metal or ammonium alkyl sulfates, alkyl sulfonic acids, fatty acids, oxyethylated alkyl phenols, and mixtures thereof. The amount of surfactant used can be from 0.1 wt % to 6 wt %, based on the weight of total monomer. Either thermal or redox initiation processes may be used in the process of the present invention. The monomer mixture for a stage may be added neat or as an emulsion in water. The monomer mixture for a stage may be added in one or more additions or continuously over the reaction period allotted for that stage. In one preferred embodiment, the addition of each stage in a single portion can be carried out.

Conventional free radical initiators may be used such as, for example, hydrogen peroxide, t-butyl hydroperoxide, ammonium and/or alkali persulfates; and mixtures thereof. For example, the free radical initiators can be used at a level of from 0.01 wt % to 3.0 wt %, based on the weight of total monomer. Redox systems using the same initiators coupled with a suitable reductant such as, for example, sodium sulfoxylate formaldehyde, sodium hydrosulfite, isoascorbic acid, sodium bisulfite and mixtures thereof may be used in the present invention at similar levels of the free radical initiators.

In one embodiment, chain transfer agents such as mercaptans may be used to lower the molecular weight of the formed polymer of one or more of the stage polymers. In a preferred embodiment, no chain transfer agent is used.

The above process usually results in the formation of at least two mutually incompatible polymer compositions, thereby resulting in the formation of at least two phases. The mutual incompatibility of two polymer compositions and the resultant multiphase structure of the polymer particles may be determined in various ways known in the art. For example, a scanning electron microscopy that uses a staining technique to emphasize the difference between the appearance of the two phases can be used in the present invention.

In still another embodiment, the multi-stage emulsion polymer useful in the present invention can be heat stable up to temperatures of 120° C. in one general embodiment, from 50° C. to 120° C. in another embodiment, from 70° C. to 120° C. in still another embodiment, and from 100° C. to 120° C. in yet another embodiment. By “heat stable”, as used herein, with reference to an emulsion polymer, it is meant that the polymer does not yellow on heating for at least 5 minutes (min).

The average particle diameter of the emulsion-polymerized polymer particles can be, for example, from 30 nanometers (nm) to 500 nm in one embodiment.

The aqueous phase, component (b), of the present invention includes water. In general, concentration of the water, component (b), used in the present invention may range generally from about 30 wt % to about 70 wt % in one embodiment.

In general, a variety of optional compounds can be added to the either the component (a) or the component (b) of the formulation or to both components (a) and (b). For example, in one embodiment, the polymer phase, in addition to the acrylic polymer described above, can include other polymers such as one or more different types of elastomers, to tailor the softness and/or flexibility of the skin. Such elastomers may include, for example, polyurethane dispersions, polyolefin dispersions, wax dispersions, and silicone dispersions, and the like.

In another embodiment, one or more other optional compounds and additives such as fillers, additives, stabilizers, pigments surfactants, can be added to the polymeric phase to meet end application requirements; or as desired without deleteriously affecting the performance of the polymeric phase. In still another embodiment, optional compounds and additives such as pigments, stabilizers, fillers can be added to the aqueous phase to meet end application requirements; or as desired without deleteriously affecting the performance of the aqueous phase. Other optional additives useful in the aqueous phase can include, for example, microbial agents and the like. In still another embodiment, optional thickeners can be added to the aqueous phase to control the viscosity of the emulsion for the purpose of providing a dispersible emulsion and carrying out the emulsion application. In yet another embodiment, optional hybrid dispersions including for example dispersions of polyolefin, silicone or PU can be added to the aqueous phase and/or the polymeric phase.

The concentration of optional compounds or additives, when used in the composition, can be generally in the range of from 0 wt % to 50 wt % in one embodiment; from 1 wt % to 30 wt % in another embodiment; and from 5 wt % to 30 wt % in still another embodiment.

In another alternative embodiment of the present invention, microspheres can be added to the acrylic polymer to provide a seam sealant with low gloss for a desired application where low gloss is a desired property of the sealant. For example, the microspheres can be made of (meth)acrylic polymers or polyurethane polymers, or mixtures thereof. The size of the microspheres can be in the range of from 1 micron (μm) to 50 μm in one general embodiment, from 1 μm to 20 μm in another embodiment, and from 5 μm to 15 μm in still another embodiment. The amount of microspheres added to the polymer can be up to 50 wt %. The combination of microspheres and polymer provide a low specular gloss at 60 degree of the material, for example, in the range of from 1 wt % to 50 wt % in one general embodiment, from 1 wt % to 25 wt % in another embodiment, and from 1 wt % 3o to 5 wt % in still another embodiment.

The embodiment of a seam sealant with low gloss using a combination of microspheres and polymer may be done by including a matting agent such as acrylic beads as the matting agent. For example, the microspheres useful in the polymer can be microspheres described in U.S. Pat. No. 7,829,626B2. The use of the microspheres to lower the gloss of the emulsion can make the resulting emulsion product viable for an A surface material even if there was some coated emulsion that seeped through the stitches of the A surface.

In one broad embodiment, the process for making the acrylic aqueous emulsion sealant coating composition of the present invention includes admixing component (a) a first polymeric phase component comprising a soft acrylic polymer resin; and (b) a second aqueous phase component comprising water as the medium, as described above; and optionally, adding any other desired optional additives to either component (a) or component (b); or to both components (a) and (b). The aqueous coating composition made from the acrylic aqueous emulsion can be prepared by techniques which are well known in the coatings art.

The present invention includes the use of aqueous emulsion where the solidification method involves film formation which is an improvement over other processes requiring the use of a crosslinking agent such as zinc salts or a curing agent. The use of an emulsion simplifies the handling and application of the emulsion; and provides a more cost-effective route to sealing the stitches of a skin material. In one preferred embodiment, the acrylic polymer used in the emulsion has to be appropriately selected to provide an emulsion with a low temperature (−30° C.) flexibility and a 120° C. thermal stability.

Also, the acrylic emulsion of the present invention, due to its polar nature, can be expected to exhibit good adhesion to PU foam as well as polar skin materials such as polyvinyl chloride (PVC), thermoplastic urethane (TPU) and thermoplastic elastomer (TPE). The present invention includes applying stitched skins with the acrylic emulsion, drying the emulsion to make a coated stitched skin that provides seam sealing. Experimental plaque samples tested have shown good sealing with the emulsions of the present invention; and foamed samples of skin materials have passed heat aging (120° C., 1,000 hours [hr]) testing. Using the emulsion with skin materials such as PVC, TPU, and TPE provides a sealed stitched skin structure with good adhesion to skin and good sealing of the stitched areas of the skin.

In addition to the above advantageous properties and benefits of the emulsion of the present invention, in other embodiments, the advantages using the emulsion of the present invention as a sealant composition can include for example:
(1) The process flexibility of being able to apply the emulsion via several ways such as spraying, painting, or casting. All of these application processes can be automation which may reduce inherent labor and cost of the process.
(2) The emulsion can be easy to apply in complex contours and tight radii.
(3) Applying emulsion sealing solution compared to using a seam tape is a simplified process.
(4) An improved sealing capability using the emulsion which can lead to a reduction in the amount of scrap produced in the process, particularly reducing the scrap rate for instrument panels (IP). Reducing scrap rate is a significant benefit to a process because typically the entire IP (which consists, e.g., of a substrate+PU foam+skin; and has high cost) has to be scrapped when a defect in the sealing part of the IP is found.
(5) Another advantage of using an acrylic emulsion compared to using a polyolefin dispersion is the ability of the acrylic emulsion to dry at room temperature (RT, about 25° C.) because acrylics in general tend to film form well at RT versus polyolefins that require a higher temperature (e.g., 50° C. to 100° C.) to form a film.
(6) Still another advantage of the acrylic emulsion of the present invention is that the acrylic emulsion has a low viscosity (˜100 millipascals-seconds (mPa-s) and the viscosity of the emulsion can be tailored (e.g., with thickeners) to allow the emulsion to penetrate the seals for better wet-out but not bleed through the stitches to show up on a Class A surface. In one general embodiment, the viscosity of the emulsion can be, for example, from 40 mPa-s to 800 mPa-s, from 50 mPa-s to 500 mPa-s in another embodiment, and from 100 mPa-s to 300 mPa-s in still another embodiment.

In one embodiment, a crosslinking agent such as a Zn salt can be used to crosslink the polymer in the emulsion. When various useful acrylic polymer compositions (described herein below) are crosslinked and the compositions are plotted as a function of Tg (° C.) and the and amount of Zn salt (crosslinking agent) present in the composition, it has been found that the acrylic polymer composition of the present invention is the optimum product based on having a low Tg and a high thermal stability due to higher crosslinking.

In one general embodiment, the solids content of the emulsion can be, for example, from 30 wt % to 80 wt %, from 30 wt % to 50 wt % in another embodiment, and from 30 wt % to 40 wt % in still another embodiment.

Besides the advantages of providing an emulsion having (1) a high temperature stability of up to a temperature of 120° C., (2) a low temperature flexibility of a temperature as low as −30° C., and (3) a low glass transition temperature (Tg) of less than −30° C.; the emulsion can also have, for example, the following benefits: ability to film form at room temperature (heat is not needed to form a sealing skin); good adhesion to skin material; and good adhesion to PU foam. The peel strength of the sealed skin members can be measured by techniques well known in the art.

Other embodiments which will become apparent to one skilled in the art and which can be encompassed within the scope of the present invention can include, for example, changing the cure chemistry of the emulsion to provide a desired property or other benefit of the emulsion. For example, the softness of the emulsion can also be altered by choice of starting materials such as acrylic monomers.

In one embodiment of the present invention, the emulsion can be formulated with thickeners, flow agents, defoamers, biocides, inorganic dullers and pigments. In a preferred embodiment the formulation is low gloss and contains a polymeric matting agent. The polymeric matting agent can include, for example, polyurethane, polyurea, polysiloxane, polyolefin, poly(meth)acrylate, and mixtures thereof. In one preferred embodiment, the polymeric matting agent can be a non-voided spherical matting agent that can have a particle size of from 1 μm to 20 μm.

Generally, the ratio of the solid polymeric matting agent to the emulsion can be from 90:10 to 10:90 in one embodiment, 70:30 in another embodiment, 60:40 in still another embodiment, 50:50 in yet another embodiment, and 40:60 in even still another embodiment. In one preferred embodiment, the organic matting agent useful in the present invention can be a multiple stage acrylic particle such as the acrylic particles described in U.S. Pat. No. 7,829,626.

Another broad embodiment of the present invention includes a sealed stitched skin structure which includes (i) a stitched skin member and (ii) a seam comprising a film or coating of the acrylic aqueous emulsion sealant coating composition described above disposed on and adhered to at least a portion of at least one of the surfaces of the stitched skin member and on the stitched holes present in the stitched skin member, wherein the film or coating is adhered to the surface of the skin member.

The skin member useful in the present invention may be made of any material that the acrylic aqueous emulsion sealant coating composition can adhere thereto. Generally, the skin member material can include various synthetic skin materials that are polar in nature. Since the acrylic emulsion of the present invention is polar in nature, the emulsion can be expected to exhibit good adhesion to the polar skin material as well as the PU foam material. In a preferred embodiment, the skin member can be made of materials including, for example, polyvinyl chloride (PVC); thermoplastic urethane (TPU); and thermoplastic elastomer (TPE); and the like; and mixtures thereof.

The skin member can be made of any thickness desired for the particular application that the stitched skin structure will be used. For example, the thickness of the skin member can be from 0.3 millimeters (mm) to 5 mm in one embodiment, from 0.5 mm to 2 mm in another embodiment, and from 0.8 mm to 1.3 mm in still another embodiment.

As aforementioned, when the acrylic aqueous emulsion sealant coating composition described above is applied to the seam of a skin member where the stitched holes of the stitches are located and the composition is dried, the dried composition forms a film or coating covering the seam/stitches. The film on the seam then seals the seam where the stitched holes in the stitched skin member are located. The film coating can be of a sufficient size (i.e., length, width and thickness) to seal the seam/stitch line (i.e., to form a barrier) to prevent polyurethane leakage from the polyurethane foam attached to the stitched skin structure. In general, the film size can be any desired size and can depend on the particular application that the stitched skin structure will be used. For example, when used in an automotive part, as an illustration and not to be limited thereby, the length of the film coating can be from 1 meter (m) to 2 m; the width of the film coating can be from 15 mm to 30 mm; and the thickness of the film can be from 0.05 mm to 1 mm.

In a broad embodiment of the present invention, a process for producing a sealed stitched skin structure includes the steps of:

(I) admixing: (a) a first polymeric phase component comprising a soft acrylic polymer resin; and (b) a second aqueous phase component comprising water as a medium; wherein the water medium comprises a continuous phase; and wherein the acrylic polymer resin comprises a dispersed phase; and wherein the admixing is carried out at process conditions to form an acrylic aqueous emulsion sealant coating composition;

(II) applying the acrylic aqueous emulsion sealant coating composition from step (I) to at least a portion of the surface of at least one side of a skin member and to the stitch holes present in the skin member to form a wet film or coating of the acrylic aqueous emulsion sealant coating composition on the surface of the skin member;

(III) drying the wet coating of sealant composition from step (II) at a temperature of from 20° C. to 100° C. and at process conditions to form a dried skin member having a dried film coating of sealant composition on at least a portion of the surface of a skin member and on the stitched holes present in the skin member, and

(IV) heating the dried skin member having a dried film coating of sealant composition from step (III) at a temperature and at process conditions sufficient to form a film or coating of the acrylic aqueous emulsion sealant coating composition on the seam of stitches/stitch holes present in the skin member, and on at least a portion of the surface of a skin member; and

(V) sealing the seam of stitches in the skin member with the film or coating from step (IV).

The admixing step (I) is carried out as described above. The application step (II) for applying the emulsion coating of the present invention to a skin member may include, for example, any one or more conventional methods known in the coating art. For example, the aqueous emulsion coating composition may be applied to the synthetic skin member using conventional coatings application methods such as a curtain coater method. spraying, casting, extruding, and painting—foam or roll brush and the like. In one preferred embodiment, a conventional coating application method used in the present invention can be, for example, a spraying method such as, air-atomized spray, air-assisted spray, airless spray, high-volume low-pressure spray, and air-assisted airless spray. In a preferred embodiment, the emulsion can be applied along a narrow (e.g., 15 centimeters (cm) to 30 cm) width of the stitch line of the skin. The aqueous emulsion coating composition may be applied to a synthetic skin member such as, PVC, TPU. TPE and the like.

The drying step (III) of the process for drying a wet sealant coating emulsion of the present invention once applied on a skin may include, for example, any one or more of the following methods: oven heating the skin and the coated skin; using IR heaters; heating the emulsion prior to applying the emulsion on a skin; and the like.

In one general embodiment, the temperature of drying the emulsion can be, for example, from 20° C. to 95° C., from 30° C. to 90° C. in another embodiment, and from 50° C. to 80° C. in still another embodiment.

The sealed stitched skin structure having the emulsion produced in accordance with the present invention advantageously has advantageous properties and benefits such as a good adhesion between the skin material and PU foam; a softness such that no aesthetic defects appear in curved areas; low temperature ductility (e.g., down to a temperature of −40° C.); and high temperature heat stability on aging (e.g., at a temperature of up to 120° C.).

For example, the sealed stitched skin structure can have a softness in the range of from 40 Shore A to 100 Shore A in one embodiment, from 50 Shore A to 90 Shore A in another embodiment, and from 60 Shore A to 80 Shore A in still another embodiment, as measured by Shore A hardness method known to those skilled in the art.

The polyurethane foamed article of the present invention includes: (A) a sealed stitched skin structure having a seam of stitched holes as described above; and (B) a polyurethane foam adhered to the seam of the film or coating and at least a portion of the surface of the skin member where the seam of the film or coating is located.

The film coating seam in the sealed stitched skin structure is sufficient to seal the stitch holes present in the stitched skin member to prevent polyurethane leakage from the polyurethane foam adhered to at least a portion of one surface of the sealed stitched skin structure.

In one broad embodiment, the process for producing a polyurethane foamed article of the present invention can include the steps of: (I) providing a sealed stitched skin structure as described above; (II) forming a polyurethane foam-forming reactive mixture composition; and (III) applying the polyurethane foam-forming composition to at least a portion of the surface of the sealed stitched skin structure where the seam of the film or coating is located. Once applied to the skin member, the polyurethane foam-forming reactive mixture composition reacts to form a PU foam. The film or coating of the sealed skin structure advantageously prevents polyurethane leakage from the polyurethane foam applied to the sealed stitched skin structure.

The process for producing a polyurethane foamed article can be carried out under conventional polyurethane foam-producing processes and conditions that are known to those skilled in the art. For example, in one embodiment, the process of producing a polyurethane foamed article can include an injection molding process where after preparing a PU foam-forming system (or PU foam-forming reactive mixture composition) and mixing the composition, the composition is injected directly into a closed mold. The mold is typically held at a temperature of, for example, from 40° C. to 70° C. The polyol and isocynate components of the PU foam-forming composition are typically held at a constant temperature of, for example, 25° C. to 50° C. The two components making up the PU foam-forming composition can be mixed with impingement mixing prior to being injected into the mold. Inside the mold, the polyurethane foam-forming reactive mixture composition reacts to form a PU foam and adheres to the skin member to which the PU foam-forming composition has been applied.

In another embodiment, an open pour method can be used to produce a polyurethane foamed article where after preparing a PU foam-forming system (or PU foam-forming reactive mixture composition) and mixing the composition, the composition is poured directly into a mold cavity and a lid for the mold cavity is secured over the mold cavity. Both the injection molding process described above and the open pour method described above are carried out in a closed mold. However, an open pour method of pouring the composition into an open mold cavity can also be used. For example, step (II) of forming a polyurethane foam-forming reactive mixture composition; and step (III) of applying the polyurethane foam-forming reactive mixture composition to the sealed stitched skin structure described in the processes above, may be carried out by injecting or pouring the polyurethane foam-forming reactive mixture composition into an open or closed mold containing the sealed stitched skin; and optionally containing a hard carrier substrate. When a hard carrier substrate is used, the PU foam can be injected in between the sealed stitched skin and the hard carrier substrate.

In still another preferred embodiment, the process for producing the polyurethane foamed article of the present invention can include the steps of:
(1) providing a stitched skin member having stitched holes;
(2) providing a sealant coating composition;
(3) providing a film coating seam derived from the sealant coating composition;
(4) sealing the stitched holes present in the stitched skin member with the film coating seam derived from the sealant coating composition; and
(5) applying a polyurethane foam-forming reactive mixture composition to the sealed skin to form a PU foam on the sealed skin.

The sealing step (4) described above can be carried out by the steps of: (α) applying the sealant coating composition to at least a portion of the surface of the stitched skin member and to the stitch holes present in the stitched skin member to form a wet coating of sealant coating composition on the stitched skin member surface; (β) drying the stitched skin member having the wet coating of sealant composition from step (α) at process conditions to form a dried skin member having a dried film coating of sealant composition on at least a portion of the surface of the stitched skin member and on the stitch holes present in the stitched skin member; and (γ) heating the dried stitched skin member having a dried film coating of sealant composition from step (β) at process conditions to form a film coating seam of sealant composition on at least a portion of the surface of the stitched skin member and on the stitch holes present in the stitched skin member sufficient to seal the stitch holes present in the stitched skin member to form a sealed stitched polyurethane foamed article.

The foam-foaming for making the polyurethane foam may include any of the conventional polyurethane systems or composition and procedures known in the art. Generally, a foam-forming composition including, a reactive mixture of a polyol component and a polyisocyanate component are mixed together and the reaction mixture is either (i) injection molded in a closed mold as described above or (ii) open poured in an open mold and then the open mold is closed as described above.

The sealed stitched skin structure having a foam backing produced in accordance with the present invention has advantageous properties and benefits. For example, the foamed piece or article has no visual defects in the stitched area as prepared or after being exposed to cold or hot temperature conditions.

The final foamed article or product including the sealed stitched skin structure having a foam backing as described above and made in accordance with the present invention can be useful in a variety of applications. For example, the foamed article can be used in automotive applications, in particular, for stitched skins used in automotive interior applications such as instrument panels (IPs), door panels (DP), armrest, consoles, trim, seating; and glove compartment; and for applications where superior haptics (soft touch) is desired.

### EXAMPLES

The following examples are presented to further illustrate the present invention in detail but are not to be construed as limiting the scope of the claims. Unless otherwise stated all parts and percentages are by weight.

Various raw materials used in the Inventive Examples (Inv. Ex.) and the Comparative Examples (Comp. Ex.) which follow are described in Table I as follows:

TABLE I
Raw Materials

| Component | Brief Description | Supplier |
|---|---|---|
| INFUSE 9530 ® | Ethylene octene block copolymer (10.4% octene), | The Dow Chemical Company |
| | 0.887 density, 5 MFR, Tm = ~123° C., heat of | (Dow) |
| | fusion = 70 J/g, 83 Shore A hardness. | |
| TPE (thermoplastic elastomer) | A mixture of INFUSE 9530 + 5% black masterbatch | The Dow Chemical Company |
| XUR38 polyol | | The Dow Chemical Company |
| TPU (thermoplastic urethane) | | Sanyo |
| PAPI 94 Isocyanate | | The Dow Chemical Company |
| Nakan DSY300/15 | Polyvinylchloride (PVC) slush grade | Nakan |
| VORANOL* CP 6001 Polyol | | The Dow Chemical Company |
| VORANOL* 230-660 Polyol | | The Dow Chemical Company |
| VORANOL* 4053 Polyol | | The Dow Chemical Company |
| SPECFLEX* 3943A Polyol | | The Dow Chemical Company |
| SPECFLEX NC 630 Polyol | | The Dow Chemical Company |
| Diethyloamine (DEOA) | | Evonik |
| Triethanol Amine (TEOA) | | Evonik |
| Jeffcat ZF-10 | Catalyst: 2-((2-(2-(dimethylamino)ethoxy)ethyl) | Evonik |
| | methylamino)ethanol | |
| Polycat 15 | Catalyst: bis(N,N-dimethyl-3-amino-propyl)amine | Huntsman |
| Diexter G 156T-63 | Hydroxyl terminated saturated polyester, OH 63-65 | COIM |
| Repitian 99375 | Colorant | Milliken Chemical |
| Water | Blowing Agent | |

### Examples 1-3 and Comparative Examples A and B—Procedure for Preparing Soft Aqueous Emulsions

In the Examples described in Table II, soft multiple stage acrylic emulsion polymers with zinc can be prepared as follows: A 4-necked round bottom flask equipped with a mechanical stirrer and reflux condenser was charged with deionized (DI) water (732.4 grams [g]) and heated to 45° C. A first monomer emulsion containing DI water (92.8 g), sodium lauryl sulfate (24.8 g, 28% active), sodium dodecylbenzene sulfonate (25.6 g, 22.5% active), butyl acrylate (550.0 g), acrylic acid (19.4 g) and phosphoethyl methacrylate (12.5 g) was prepared separately. The entire monomer emulsion was added and rinsed to a reactor; and then, solutions of iron sulfate (0.004 g in 4.3 g water), ammonium persulfate (0.41 g in 6 g water) and Lykopon/sodium hydroxide (0.68 g/0.12 g in 14 g water) were sequentially added to the reactor at which time an exotherm to 87° C. was observed. After the reaction peaked, the contents of the reactor were cooled to 65° C.; and then, methyl methacrylate (61.6 g) was charged to the reactor. Solutions of t-butylhydroperoxide (0.28 g in 4 g water) and sodium sulfoxylate formaldehyde (0.18 g in 12 g water) were added to the reactor and an exotherm to 63° C. was observed. Additional solutions of t-butylhydroperoxide (0.92 g in 21.6 g water) and sodium sulfoxylate formaldehyde (0.62 g in 21.6 g water) were added to the reactor to reduce residual monomers. Then, ammonium hydroxide (1.54 g) was added to the reactor. A slurry made from DI water (34 g) and zinc oxide (9.86 g) was added to the reactor over 15 min. The reactor contents were held at 40° C. for 1 hour, and then additional ammonium hydroxide (15 g) was added to the reactor. The resulting emulsion had a solids content of 34.4% and a pH of 8.9.

TABLE II
Soft Multiple Stage Acrylic Emulsion Containing Zinc Examples

| | % BA | % EA | % PEM | % AA | % MMA | Ratio of | Molar Equivalents |
|---|---|---|---|---|---|---|---|
| Example | in Stage 1 | in Stage 1 | in Stage 1 | in Stage 1 | in Stage 2 | Stage 1:Stage2 | of Zn: AA |
| Inv. Ex. 1 | 94.5 | 0 | 2.2 | 3.3 | 100 | 9:1 | 0.9 |
| Inv. Ex. 2 | 96.5 | 0 | 0 | 3.5 | 100 | 9:1 | 0.9 |
| Inv. Ex. 3 | 0 | 96.5 | 0 | 3.5 | 100 | 9:1 | 0.9 |
| Comp. Ex. A | 96.5 | 0 | 0 | 3.5 | 100 | 8:2 | 0 |
| Comp. Ex. B | 0 | 96.5 | 0 | 3.5 | 0 | 10:0 | 0.7 |

In Table I, BA is butyl acrylate; EA is ethyl acrylate; PEM is phosphoethyl methacrylate; AA is acrylic acid; and MMA is methyl methacrylate.

In these examples, the skin materials used included TPE (thermoplastic elastomer) which was INFUSE 9530+5% black masterbatch; PVC which was a slush grade PVC (Nakan DSY300/15); and TPU which was a thermoplastic urethane (Sanyo TU-318H).

In these examples, the PU foam used included an instrument panel foam system (XUR38 polyol/PAPI 94 Isocyanate) and the foam system was used to back foam skins. PAPI 94 Isocyanate, XUR38 Polyol (composition described below in Table III), 100 Index, 8.5 pounds per cubic feet (pcf) density foam.

TABLE III
Polyol Component of PU Foam System

| Component | | |
|---|---|---|
| Function | Components | % |
| Polyols | VORANOL* CP 6001 Polyol | 57.00 |
| | VORANOL* 230-660 Polyol | 5.00 |
| | VORANOL* 4053 Polyol | 2.00 |
| | SPECFLEX* 3943A Polyol | 5.00 |
| | SPECFLEX NC 630 Polyol | 21.50 |
| Crosslinkers | Diethyloamine (DEOA) | 0.30 |
| | Triethanol Amine (TEOA) | 0.70 |
| Catalysts | Jeffcat ZF-10 | 0.30 |
| | [2-((2-(2-(Dimethylamino)ethoxy)ethyl) | |
| | methylamino)ethanol Catalyst] | |
| | Polycat 15 | 0.90 |
| | Bis(N,N-dimethyl-3-amino-propyl)amine | |
| Adhesion | Diexter G 156T-63 | 4.00 |
| Promoter | [Hydroxyl terminated saturated polyester, | |
| | OH 63-65] | |
| Colorant | Repitian 99375 | 0.30 |
| Blowing Agent | Water | 3.10 |
| | Total Polyol Components | 100.00 |

### General Procedure for Foaming of Dried Skins

The foaming was carried out in a 2× Mold (500 cm×500 cm×1.3 cm) using a high pressure Graco machine. The PU system described above was used (100 index, 8.5 pcf density). The coated skins from above were placed in the mold with the grained surface on the bottom and the coated stitched side on the top. A liquid mixture of isocyanate and polyol was poured on top of the skin and the mold was closed to continue and complete the foaming process.

### General Procedure for the Adhesion of Acrylic Emulsion to Skin Materials

A soft multiple stage acrylic polymer (Example 2) 35% solid emulsion was coated on a 2 inches×2 inches skin sample to check inherent adhesion to PU foam. The emulsion of Example 2 is a milky white liquid with a viscosity that is close to that of water (˜50 cps). The emulsion can be applied using a foam brush or the emulsion can be sprayed with a paint gun.

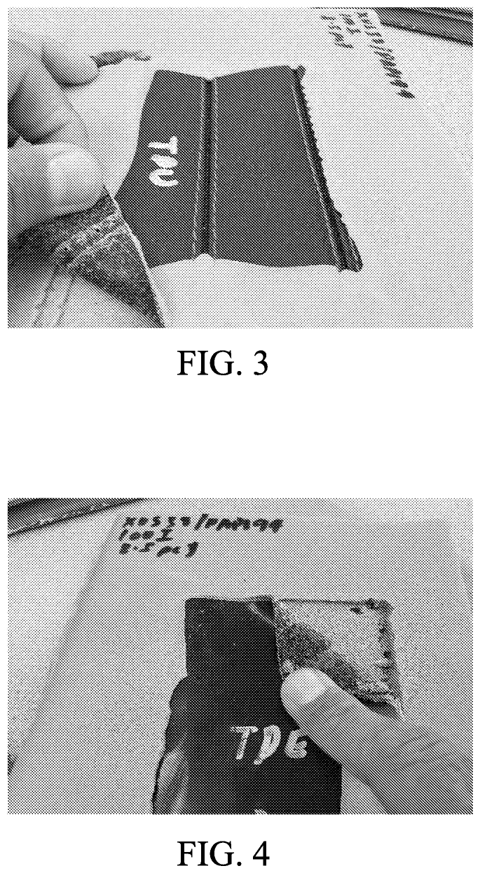

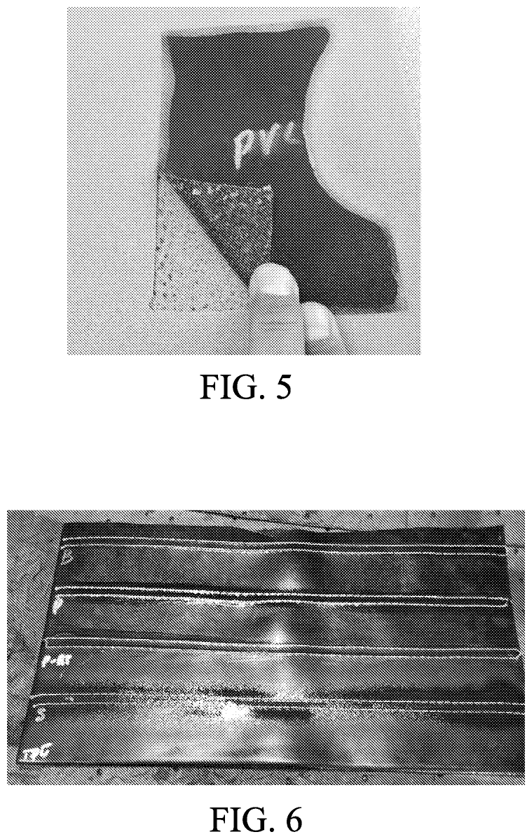

The coated skins (shown in FIGS. 3-5) showed good adhesion to all the skin materials (TPU, TPE, PVC) itself. The coated skins were subsequently foamed on the coated side. On peeling the skins off the PU foam, there was clear cohesive failure with PU foam visible on the skin. No delamination of the skin off the foam was observed which indicated that a good adhesion was achieved.

### General Procedure for Coating Stitched Skins

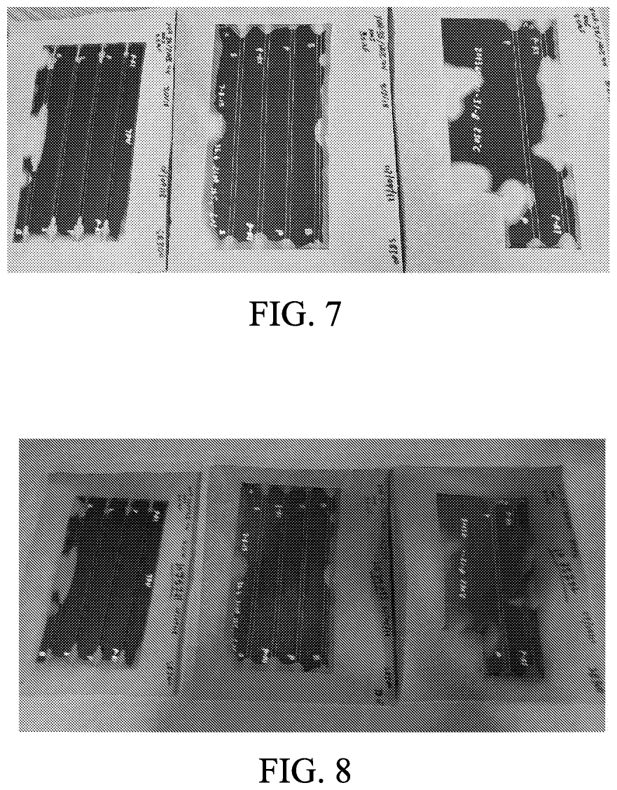

PVC, TPU and TPE grained skins (10 inches×12 inches) that were previously made on a lab scale slush molding machine were used. A seam stitching periodically spaced pattern was added using a stitching machine. The stitched PVC, TPU and TPE skin samples used are shown FIG. 7. The skins were either coated at room temperature (RT) or coated after being pre-heated in a conventional oven set at 60 CC. An example of the coated stitched skin is shown in FIG. 6. The skins were coated in the stitched areas of skins with the polymer emulsion of Example 2 either by spraying with a spray gun or painting with a foam brush. The coated or sprayed skins were placed in the oven to dry out the emulsion. 1-2 layers of spray or painted coatings were applied to the skins. Overall the painted emulsion showed better wet-out and adhesion to the PVC skin compared to the sprayed emulsion.

### General Procedure for PU Foaming and Heat Aging Foamed Samples

The foaming was carried out in a 2× Mold (20 inches×20 inches×0.5 inch) using a high pressure Graco machine. The coated skins from above were placed in in the mold with the grained surface on the bottom and the coated stitch side on the top. A polyurethane foam was molded to a coated skin by first pouring a liquid reactive mixture of an isocyanate and polyol on top of the skin and then closing the mold and heating the mold to allow the mixture to react which starts the foaming process. In 2-3 min, the foaming process was complete; and the foam adhered to the skin was formed. The foam/skin article was then removed from the mold.

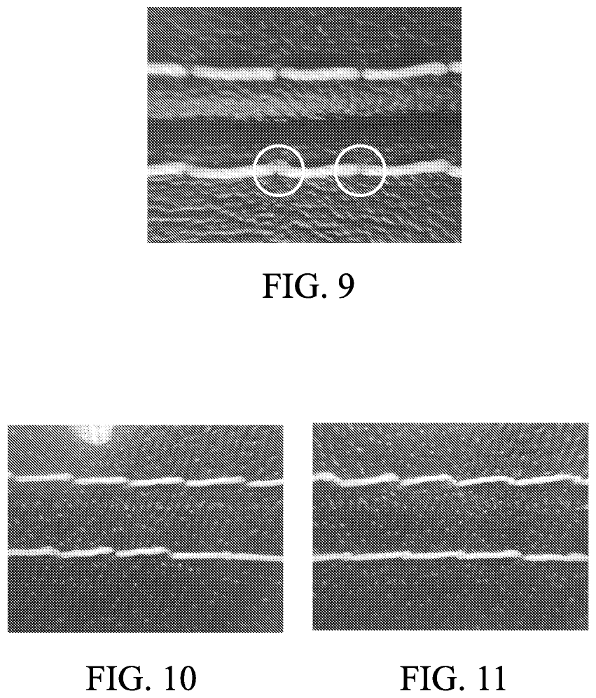

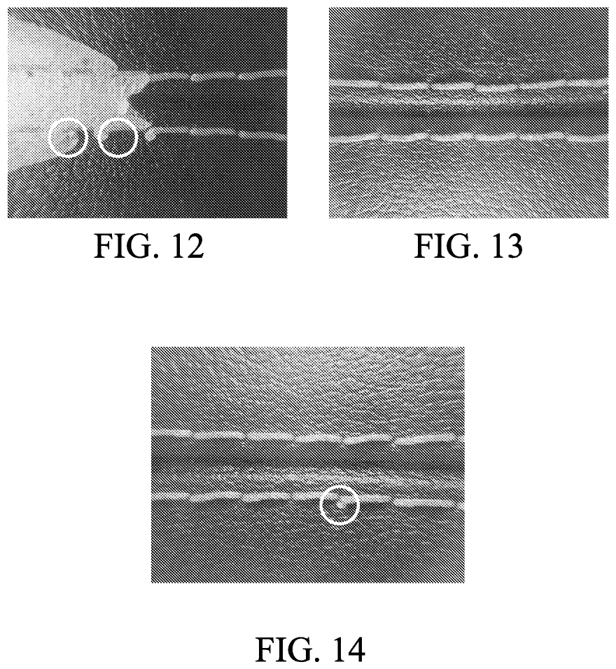

In FIG. 7, there is shown a picture of various foamed skins. As expected, there was significant foam leakage at the stitch holes for the blank sample of PVC skin. For both the RT-painted PVC skin samples and the oven-heated painted PVC skin samples, the stitches present in the samples showed excellent sealing and no foam leakage at the stitches. (see FIG. 7 C). The seal sealing seen in the foamed samples was retained after heat aging at 120° C. and 1,000 hr. FIG. 8 shows the picture of the same foamed samples described above after heat aging; and, as shown in FIG. 8, there is no visual change in the stitched areas. For the TPU sample, the blank sample (with no coating) showed significant foam leakge (see A of FIG. 9). For both the RT-painted TPE skin (see FIG. 10) and the oven-heated painted TPE skin (see FIG. 11), the stitches showed no leakage. For the TPU skin, the blank (no coating) sample showed leakage in the stitch holes (see FIG. 12). Fot the painted sample there was no leakage (see FIG. 13). For the sprayed stitches there was occasional leakage (see FIG. 14). The above results is consistent with the poorer wet-out seen with the spray method. In the case of using a spray method, a thicker coating may be applied.

What is claimed is:

1. An acrylic aqueous emulsion sealant coating composition for sealing stitched skins to prevent polyurethane leakage from polyurethane foamed stitched skins comprising:
(a) a first polymeric phase component comprising a soft acrylic polymer resin; and
(b) a second aqueous phase component comprising water as a medium; wherein the water medium comprises a continuous phase; and wherein the acrylic polymer resin comprises a dispersed phase.

2. A process for producing an acrylic aqueous emulsion sealant coating composition comprising:
(a) a first polymeric phase component comprising a soft acrylic polymer resin; and
(b) a second aqueous phase component comprising water as a medium; wherein the water medium comprises a continuous phase; and wherein the acrylic polymer resin comprises a dispersed phase.

3. A film or coating made from the acrylic aqueous emulsion sealant coating composition of claim 1.

4. A sealed stitched skin structure comprising (i) a stitched skin member; and (ii) a film or coating of claim 3 adhered to at least one side of the stitched seam skin member.

5. A process for producing a sealed stitched seam skin structure comprising the steps of:
(I) applying an acrylic aqueous emulsion sealant coating composition of claim 1 to at least a portion of the surface of at least one side of a skin member having stitches to form a wet film or coating of the acrylic aqueous emulsion sealant coating composition on the surface of the skin member;
(II) drying the wet coating from step (II) on the skin member surface at a temperature of from 20° C. to 100° C.; and
(III) sealing the stitches in the seams of in the skin member with the film or coating from step (II).

6. The process of claim 5, wherein the applying step (I) is carried out by painting or spraying, casting, or extruding.

7. A polyurethane foamed article comprising:
(A) a sealed stitched skin structure of claim 4; and
(B) a polyurethane foam applied to the skin member including the stitched seams of the skin member.

8. A process for producing a polyurethane foamed article comprising:
(I) providing a sealed stitched skin structure of claim 4; and
(II) applying a polyurethane foam to the surface of the stitched skin member, wherein the sealed stitched skin prevents polyurethane leakage from the polyurethane foam applied to the sealed stitched skin structure.

9. The process of claim 8, wherein the applying step (II) of the polyurethane foam to the sealed stitched skin structure is carried out (a) by injection or (b) by open pouring in a mold which is subsequently closed with a lid closure.
